(19) United States
(12) Patent Application Publication
(10) Pub. No.: US 2022/0148556 A1
(43) Pub. Date: May 12, 2022

(54) ELECTRONIC DEVICE FOR MANAGING TASK RELATING TO PROCESSING OF AUDIO SIGNAL,AND OPERATION METHOD THEREFOR

(71) Applicant: Samsung Electronics Co., Ltd., Suwon-si (KR)

(72) Inventors: Zuzanna KWIATKOWSKA, Warsaw (PL); Mateusz MATUSZEWSKI, Warsaw (PL); Michal KOSMIDER, Warsaw (PL); Jakub TKACZUK, Warsaw (PL); Krzysztof RYKACZEWSKI, Warsaw (PL)

(21) Appl. No.: 17/445,107

(22) Filed: Aug. 16, 2021

(30) Foreign Application Priority Data
Nov. 11, 2020 (KR) 10-2020-0150147

(51) Int. Cl. G10K 11/178; G10L 25/84; G10L 15/16; G10L 15/32

(52) U.S. Cl. CPC G10K 11/17827; G10L 25/84; G10K 2210/3038; G10L 15/32; G10K 2210/1081; G10L 15/16

(57) ABSTRACT

An electronic device includes a communication module, and a processor. The processor is configured to identify context information. The processor is also configured to select a specific task corresponding to the context information from among predetermined inference tasks relating to processing of an audio signal The processor is further configured to select an external electronic device, which is to process the specific task, from among external electronic devices that are establishing a communication connection to the electronic device. Additionally, the processor is configured to assign processing of the specific task to the external electronic device.

### CROSS-REFERENCE TO RELATED APPLICATION

This application is based on and claims priority under 35 U.S.C. 119 to Korean Patent Application No. 10-2020-0150147, filed on Nov. 11, 2020, in the Korean Intellectual Property Office, the disclosure of which is herein incorporated by reference in its entirety.

### BACKGROUND

### 1. Field

Various embodiments relate to a method and device for managing a task relating to processing of an audio signal on the basis of context information.

### 2. Description of Related Art

In the current times, many people are constantly exposed to various sounds and, among the various sounds, sounds of interest, which are sounds that inform of a dangerous situation, including a car horn sound, an emergency sound from a fire alarm, and a baby crying sound, require special attention from many people.

A sound signal for recognizing the sounds of interest may be divided into a sound event and a sound scene, wherein the sound event refers to a sound that is generated in a short moment, for example, a crash sound, a horn sound, a clapping sound, etc., and the sound scene refers to a sound that may be identified by hearing, for a relatively longer time compared to the sound event, a sound of a place where a user is located, such as in a park, a subway station, and a bus. In relation to the sound recognition technology, Korean Patent Publication No. 10-2013-0097872 (title of the invention: Sound analyzing and recognizing method and system for hearing-impaired people, publication date: Sep. 4, 2013) has been disclosed.

### SUMMARY

There is a problem that a user cannot pay attention to the sound of interest, which indicates a dangerous situation, in a state where the user wears a wearable device (e.g., earphones or headphones) on his/her ears.

Further, if the wearable device uses neural network models required for processing (e.g., sound scene classification or sound event detection) of audio signals uniformly without considering a specific context, since the wearable device attempts to detect a sound event that is impossible to be generated in a specific situation, a problem of wasting unnecessary resources occurs.

Resources that can be used in a wearable device are very limited, and thus there is a problem that a single hearable device is unable to process more than a certain number of neural network models.

Various embodiments may provide an electronic device which selects a specific task relating to processing of an audio signal, on the basis of context information, and dynamically assigns the specific task to an external electronic device.

According to various embodiments, an electronic device may include a communication module, and a processor, wherein the processor is configured to: identify context information; select a specific task corresponding to the context information from among predetermined inference tasks relating to processing of an audio signal; select an external electronic device, which is to process the specific task, from among external electronic devices that are establishing a communication connection to the electronic device; and assign processing of the specific task to the external electronic device.

According to various embodiments, an operation method of an electronic device may include: identifying context information; selecting a specific task corresponding to the context information from among predetermined inference tasks relating to processing of an audio signal; selecting an external electronic device, which is to process the specific task, from among external electronic devices that are establishing a communication connection to the electronic device; and assigning processing of the specific task to the external electronic device.

According to various embodiments, an electronic device can identify context information, select an inference task corresponding to the identified context information, and dynamically assign the inference task to an external electronic device, so as to prevent a waste of resource use and efficiently manage a task relating to processing of an audio signal.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates a block diagram of an electronic device in a network environment according to various embodiments;

FIG. 2 illustrates a flowchart for describing a method for assigning, by an electronic device, a specific task to an external electronic device on the basis of context information according to various embodiments;

FIG. 3 illustrates a diagram for describing an operation of assigning, by an electronic device, a specific task to an external electronic device on the basis of context information according to various embodiments;

FIG. 4A illustrates a diagram of an embodiment, in which an electronic device assigns a specific task to an external electronic device on the basis of context information, according to various embodiments;

FIG. 4B illustrates a diagram of an embodiment, in which an electronic device assigns a specific task to an external electronic device on the basis of context information, according to various embodiments;

FIG. 4C illustrates a diagram of an embodiment, in which an electronic device assigns a specific task to an external electronic device on the basis of context information, according to various embodiments;

FIG. 5 illustrates a diagram of an embodiment, in which an electronic device identifies context information by using information received from an external electronic device and assigns the specific task to the external electronic device on the basis of the identified context information, according to various embodiments;

FIG. 6A illustrates a flowchart for describing a method for selecting, by an electronic device, an external electronic device to process a specific task according to various embodiments;

FIG. 6B illustrates a diagram of an embodiment, in which an electronic device selects an external electronic device to process a specific task, according to various embodiments;

FIG. 7 illustrates a diagram of an embodiment, in which an electronic device updates context information and assigns a specific task to an external electronic device on the basis of the updated context information, according to various embodiments; and

FIG. 8 illustrates a flowchart for describing a method for performing, by an external electronic device, a specific task assigned by an electronic device according to various embodiments.

### DETAILED DESCRIPTION

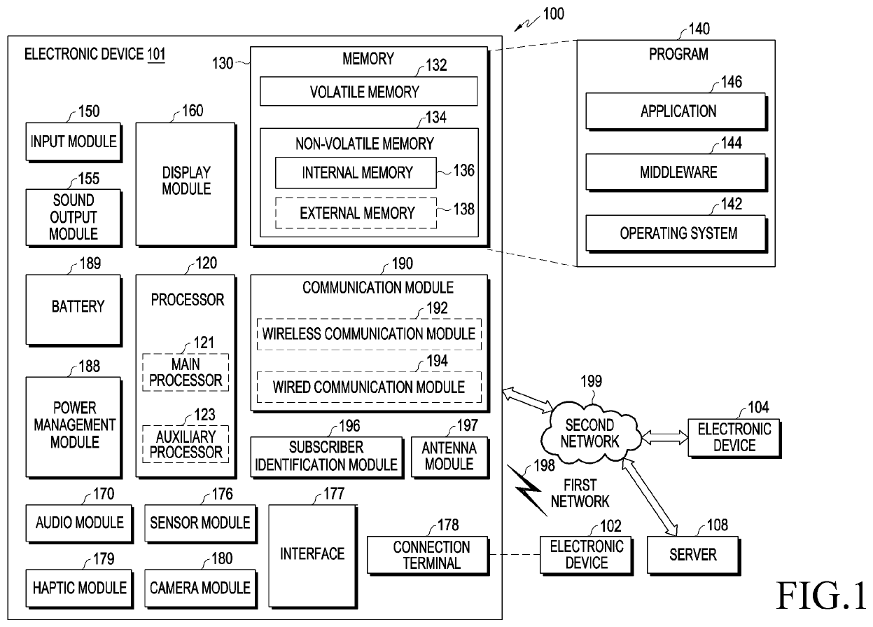

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

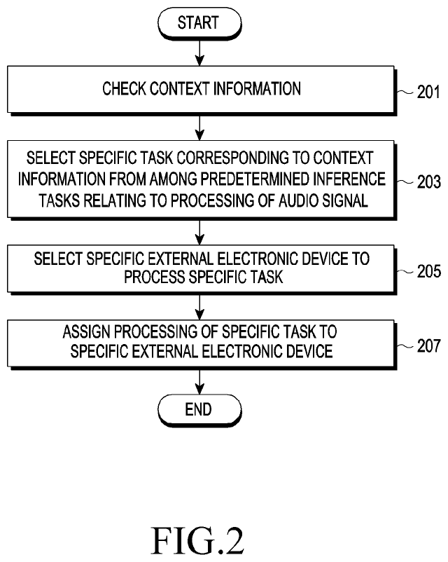

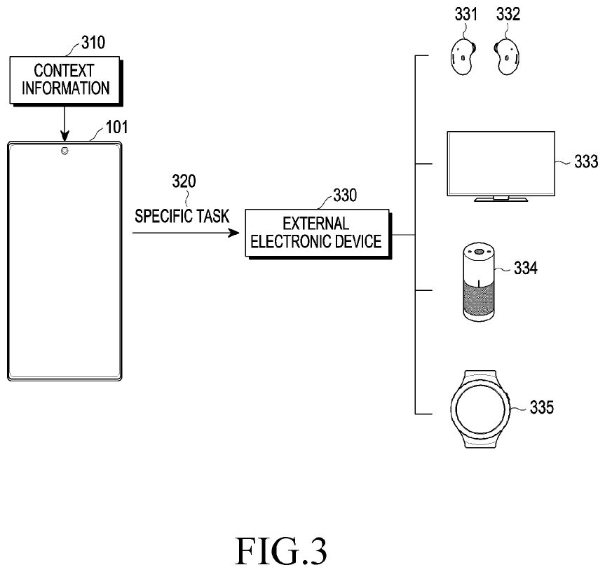

FIG. 2 illustrates a flowchart for describing a method for assigning, by an electronic device (e.g., the electronic device 101 of FIG. 1), a specific task (e.g., a specific task 320 of FIG. 3) to an external electronic device (e.g., an external electronic device 330 of FIG. 3) on the basis of context information (e.g., context information 310 of FIG. 3).

FIG. 3 illustrates an embodiment in which the electronic device 101 assigns the specific task 320 to the external electronic device 330 on the basis of the context information 310 according to various embodiments.

According to various embodiments, in operation 201, the electronic device 101 (e.g., the processor 120 of FIG. 1) may identify the context information 310. According to an embodiment, the context information 310 may include at least one of context information relating to the electronic device 101, context information relating to the external electronic device 330 (e.g., the electronic device 102 of FIG. 1), or context information relating to an audio signal.

According to an embodiment, the context information relating to the electronic device 101 may include at least one of location information of the electronic device 101, information acquired via a sensor module (e.g., the sensor module 176 of FIG. 1) of the electronic device 101, or information on an application currently being executed in the electronic device 101. According to an embodiment, the electronic device 101 may identify whether the location of the electronic device 101 corresponds to a pre-registered specific location, by using GPS information. For example, the electronic device 101 may identify that the GPS information of the electronic device 101 matches the pre-registered location information (e.g., home).

According to an embodiment, the context information relating to the external electronic device 330 may include at least one of location information of the external electronic device 330, information acquired via a sensor module of the external electronic device 330, or information on an application currently being executed in the external electronic device 330. According to an embodiment, the electronic device 101 may request context information relating to the external electronic device 102 from the external electronic device 102, and may receive the context information from the external electronic device 102.

According to an embodiment, the context information relating to an audio signal may include surrounding environment information of the electronic device 101. According to an embodiment, the electronic device 101 may identify the surrounding environment information of the electronic device 101 by using a neural network model for classifying a sound scene. Classification of the sound scene may represent an operation of identifying the type of the surrounding environment (e.g., in a house, outdoors, in a subway, in a bus, etc.) of the electronic device 101 by detecting an ambient sound of the electronic device 101 and applying the detected ambient sound to the neural network model. For example, the electronic device 101 may perform a sound scene classification task to identify that the surrounding environment information of the electronic device 101 corresponds to outdoor. According to an embodiment, the electronic device 101 may identify the surrounding environment information of the electronic device 101 on the basis of the audio signal received from the external electronic device 330 or a result of processing the specific task 320, which is received from the external electronic device 330.

According to various embodiments, in operation 203, the electronic device 101 (e.g., the processor 120 of FIG. 1) may select the specific task 320 corresponding to the context information 310 from among predetermined inference tasks relating to processing of the audio signal. The predetermined inference tasks may include various tasks, such as baby crying sound detection, doorbell sound detection, siren alarm detection, smoke alarm detection, fire alarm detection, car horn sound detection, pet sound detection, active noise cancellation and sound quality enhancement, signal-to-noise ratio (SNR) estimation, and sound scene classification, and each inference task may be performed using a corresponding neuro network model. For example, referring to FIG. 3, the electronic device 101 may select the specific task 320 corresponding to the context information 310 from among the predetermined inference tasks. According to an embodiment, each inference task may be preconfigured by a user of the electronic device 101 or a manufacturer of the electronic device 101 so as to correspond to specific context information.

According to various embodiments, the electronic device 101 (e.g., the processor 120 of FIG. 1) may select the specific task 320 corresponding to the context information 310 by using a neural network model learned on the basis of context information and a task performance result corresponding to the context information. According to an embodiment, the electronic device 101 may train a neural network model by using, as learning data, context information corresponding to a specific situation and a result of processing a task performed in the specific situation, and may apply the context information 310, which is input later, to the trained neural network model, so as to select the specific task 320 corresponding to the context information 310.

According to various embodiments, the electronic device 101 (e.g., the processor 120 of FIG. 1) may select the specific task 320 corresponding to location information of the electronic device 101. For example, the electronic device 101 may select the specific task 320 (e.g., detection of a pet sound) corresponding to first location information (e.g., room 1 at home) of the electronic device 101. As another example, the electronic device 101 may select the specific task 320 (e.g., detection of a baby crying sound) corresponding to second location information (e.g., room 2 at home) of the electronic device 101.

According to various embodiments, the electronic device 101 (e.g., the processor 120 of FIG. 1) may select the specific task 320 corresponding to surrounding environment information of the electronic device 101. For example, the electronic device 101 may select the specific task 320 (e.g., detection of a car horn sound) corresponding to first surrounding environment information (e.g., outdoor) of the electronic device 101. As another example, the electronic device 101 may select the specific task 320 (e.g., noise cancellation) corresponding to second surrounding environment information (e.g., in a subway station) of the electronic device 101.

According to various embodiments, the electronic device 101 (e.g., the processor 120 of FIG. 1) may select a plurality of specific tasks corresponding to the context information 310. For example, the electronic device 101 may select a first specific task (e.g., doorbell alarm detection) and a second specific task (e.g., fire alarm detection) which correspond to the location information (e.g., home) of the electronic device 101 from among predetermined inference tasks.

According to various embodiments, in operation 205, the electronic device 101 (e.g., the processor 120 of FIG. 1) may select the external electronic device 330 (e.g., the electronic device 102 of FIG. 1) to process the specific task 320 from among external electronic devices which are establishing a communication connection to the electronic device 101 via a communication module (e.g., the communication module 190 of FIG. 1). For example, referring to FIG. 3, the external electronic devices, which are establishing a communication connection to the electronic device 101, may include earbuds including a first external electronic device (such as a left earbud 331) and a second external electronic device (such as a right earbud 332), a smart TV 333, an artificial intelligence speaker 334, and a smart watch 335. The above-described example of the external electronic devices are only an embodiment, and the external electronic devices are not limited thereto and may be implemented in various forms of electronic devices. According to an embodiment, the electronic device 101 may select a specific device to process the specific task 320 from among a plurality of electronic devices including the electronic device 101 and external electronic devices.

According to various embodiments, the electronic device 101 (e.g., the processor 120 of FIG. 1) may select a plurality of external electronic devices to process the specific task 320 from among the external electronic devices which are establishing a communication connection to the electronic device 101. For example, the electronic device 101 may select the specific task 320 (e.g., noise cancellation), and then may select the left earbud 331 and the right earbud 332 as devices to process the specific task 320.

According to various embodiments, the electronic device 101 (for example, the processor 120 of FIG. 1) may select the external electronic device 330 corresponding to the specific task 320 by using a mapping table indicating a relationship between an inference task and an external electronic device. According to an embodiment, an external electronic device capable of processing each of predetermined inference tasks may be designated in advance. For example, the left earbud 331 may be pre-designated to process a doorbell alarm detection task, a car horn detection task, and a noise cancellation task, the right earbud 332 may be pre-designated to process a fire alarm detection task and a noise cancellation task, the smart TV 333 may be pre-designated to process a sound quality improvement task, and the artificial intelligence speaker 334 may be pre-designated to process a baby crying detection task. Association relationships between the specific task 320 and the external electronic device 330 may be stored in a memory (e.g., the memory 130 of FIG. 1) in the form of a mapping table.

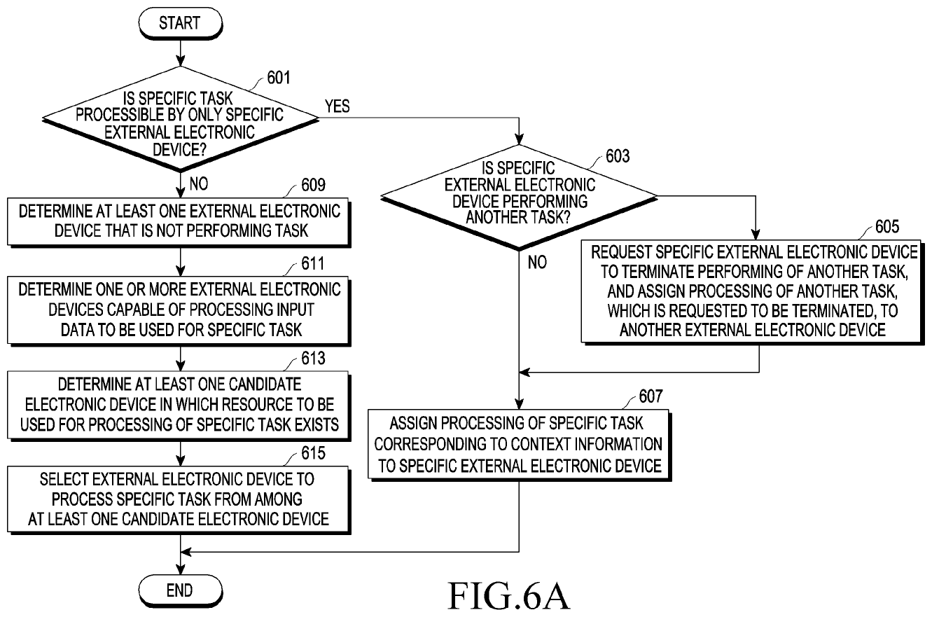

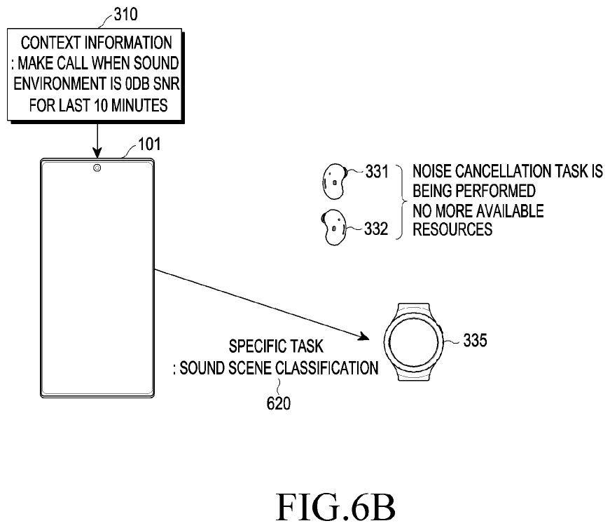

According to various embodiments, the electronic device 101 (e.g., the processor 120 of FIG. 1) may use various methods to select the external electronic device 330, and specific operations related thereto will be described later in FIG. 6A and FIG. 6B.

According to various embodiments, in operation 207, the electronic device 101 (e.g., the processor 120 of FIG. 1) may assign processing of the specific task 320 to the external electronic device 330. For example, referring to FIG. 3, the electronic device 101 may request or assign processing of the specific task 320 to the external electronic device 330 via the communication module 190. According to an embodiment, the electronic device 101 may transmit a request for processing the specific task 320 to the external electronic device 330, via the communication module 190, while transmitting, along with the request, a neural network model, which is used for processing the specific task 320, to the external electronic device 330. According to an embodiment, if the electronic device 101 is selected as a device to process the specific task 320, the electronic device 101 may not assign processing of the specific task 320 to the external electronic device 330, and may directly process the specific task 320.

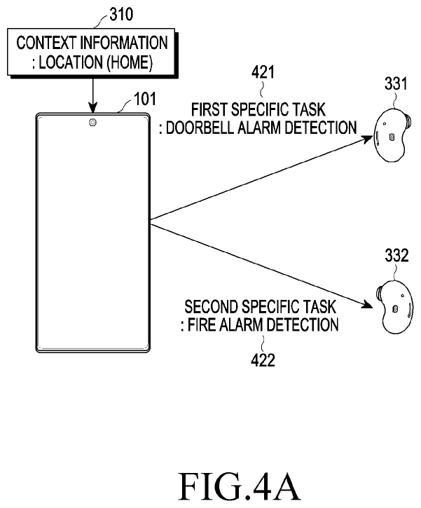

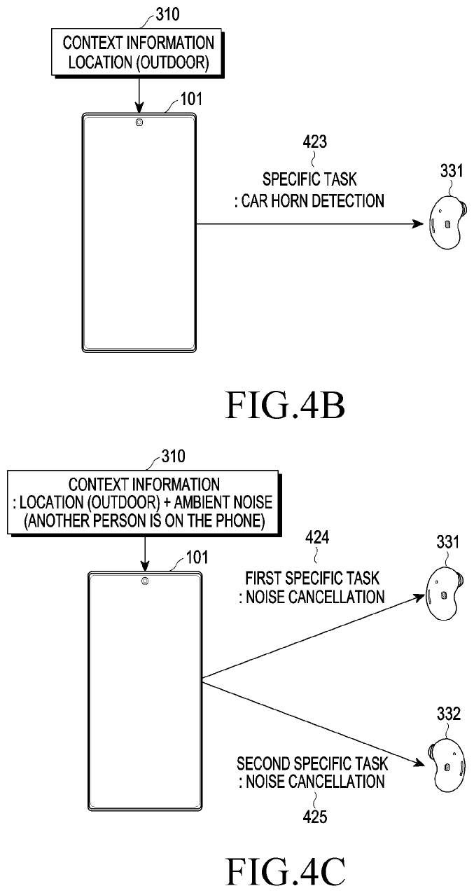

According to various embodiments, FIG. 4A illustrates a diagram illustrating an embodiment, in which an electronic device (e.g., the electronic device 101 of FIG. 1) assigns a specific task (e.g., the specific task 320 of FIG. 3) to an external electronic device (e.g., the external electronic device 330 of FIG. 3) on the basis of context information (e.g., the context information 310 of FIG. 3).

According to various embodiments, the electronic device 101 (e.g., the processor 120 of FIG. 1) may identify location information of the electronic device 101, as the context information 310. For example, referring to FIG. 4A, the electronic device 101 may identify that location information of the electronic device 101 corresponds to “home”.

According to various embodiments, the electronic device 101 (e.g., the processor 120 of FIG. 1) may select the specific task 320 corresponding to the location information of the electronic device 101 from among predetermined inference tasks. For example, referring to FIG. 4A, the electronic device 101 may select a first specific task 421 (e.g., doorbell alarm detection) and a second specific task 422 (e.g., fire alarm detection) which correspond to “home”.

According to various embodiments, the electronic device 101 (e.g., the processor 120 of FIG. 1) may select the external electronic device 330 to process the specific task 320 from among external electronic devices which are establishing a communication connection to the electronic device 101. For example, referring to FIG. 4A, the electronic device 101 may select the first external electronic device 331 (e.g., a left earbud) to process the first specific task 421 and the second external electronic device 332 (e.g., a right earbud) to process the second specific task 422.

According to various embodiments, the electronic device 101 (e.g., the processor 120 of FIG. 1) may assign processing of the specific task 320 to the external electronic device 330. For example, referring to FIG. 4A, the electronic device 101 may assign processing of the first specific task 421 to the first external electronic device 331 and may assign processing of the second specific task 422 to the second external electronic device 332. In this case, the electronic device 101 may transmit a first neural network model (e.g., doorbell alarm detection model) for processing the first specific task 421 to the first external electronic device 331, and may transmit a second neural network model (e.g., fire alarm detection model) for processing the second specific task 422 to the second external electronic device 332.

According to various embodiments, FIG. 4B illustrates a diagram of an embodiment, in which an electronic device (e.g., the electronic device 101 of FIG. 1) assigns a specific task (e.g., the specific task 320 of FIG. 3) to an external electronic device (e.g., the external electronic device 330 of FIG. 3) on the basis of context information (e.g., the context information 310 of FIG. 3).

According to various embodiments, the electronic device 101 (e.g., the processor 120 of FIG. 1) may identify surrounding environment information of the electronic device 101, as the context information 310. According to an embodiment, the electronic device 101 may identify the surrounding environment information of the electronic device 101 by using a neural network model for classification of a sound scene. For example, referring to FIG. 4B, the electronic device 101 may identify audio data corresponding to an ambient sound acquired via a microphone (e.g., the input module 150 of FIG. 1) inside the electronic device 101 or audio data corresponding to an ambient sound acquired via a microphone of an external electronic device (e.g., earbuds or smart watch), which is establishing a communication connection to the electronic device 101, and may apply the identified audio data to the neural network model for classification of a sound scene, so as to identify that the surrounding environment of the electronic device 101 corresponds to outdoor and there is no ambient noise. According to an embodiment, the electronic device 101 may identify an update of context information. For example, referring to FIG. 4A and FIG. 4B, the electronic device 101 may confirm that the surrounding environment of the electronic device 101 has been changed from “home” to “outdoor without ambient noise”, and may update the context information according to the changed context.

According to various embodiments, the electronic device 101 (e.g., the processor 120 of FIG. 1) may select the specific task 320 corresponding to the surrounding environment information of the electronic device 101 from among predetermined inference tasks. For example, referring to FIG. 4B, the electronic device 101 may select a specific task 423 (e.g., car horn detection) corresponding to “outdoor without ambient noise”.

According to various embodiments, the electronic device 101 (e.g., the processor 120 of FIG. 1) may select the external electronic device 330 to process the specific task 320 from among external electronic devices which are establishing a communication connection to the electronic device 101. For example, referring to FIG. 4B, the electronic device 101 may select the first external electronic device 331 to process the specific task 423.

According to various embodiments, the electronic device 101 (e.g., the processor 120 of FIG. 1) may assign processing of the specific task 320 to the external electronic device 330. For example, referring to FIG. 4B, the electronic device 101 may assign processing of the specific task 423 to the first external electronic device 331. In this case, the electronic device 101 may transmit a neural network model (e.g., car horn detection model) for processing the specific task 423 to the first external electronic device 331. According to an embodiment, the electronic device 101 may request the external electronic device 330 to terminate performing of a task that does not correspond to the context information 310. For example, referring to FIG. 4A and FIG. 4B, the electronic device 101 may request the first external electronic device 331 to terminate the first specific task 421 (e.g., doorbell alarm detection task) corresponding to previous context information (e.g., home), and may request the second external electronic device 332 to terminate the second specific task 422 (e.g., fire alarm detection task) corresponding to the previous context information (e.g., home).

According to various embodiments, FIG. 4C illustrates a diagram of an embodiment, in which an electronic device (e.g., the electronic device 101 of FIG. 1) assigns a specific task (e.g., the specific task 320 of FIG. 3) to an external electronic device (e.g., the external electronic device 330 of FIG. 3) on the basis of context information (e.g., the context information 310 of FIG. 3).

According to various embodiments, the electronic device 101 (e.g., the processor 120 of FIG. 1) may identify surrounding environment information of the electronic device 101, as the context information 310. For example, referring to FIG. 4C, the electronic device 101 may identify audio data corresponding to an ambient sound acquired via a microphone (e.g., the input module 150 of FIG. 1) inside the electronic device 101 or audio data corresponding to an ambient sound acquired via a microphone of an external electronic device (e.g., earbuds or smart watch), which is establishing a communication connection to the electronic device 101, and may apply the identified audio data to the neural network model for classification of a sound scene, so as to identify that the surrounding environment of the electronic device 101 corresponds to outdoor and another person is on the phone. According to an embodiment, the electronic device 101 may identify an update of context information. For example, referring to FIG. 4B and FIG. 4C, the electronic device 101 may confirm that the surrounding environment of the electronic device 101 has been changed from “outdoor” to “outdoor where another person is on the phone”, and may update the context information according to the changed context.

According to various embodiments, the electronic device 101 (e.g., the processor 120 of FIG. 1) may select the specific task 320 corresponding to the surrounding environment information of the electronic device 101 from among predetermined inference tasks. For example, referring to FIG. 4C, the electronic device 101 may select a first specific task 424 (e.g., noise cancellation) and a second specific task 425 (e.g., noise cancellation) which correspond to “outdoor where another person is on the phone”.

According to various embodiments, the electronic device 101 (e.g., the processor 120 of FIG. 1) may select the external electronic device 330 to process the specific task 320 from among external electronic devices which are establishing a communication connection to the electronic device 101. For example, referring to FIG. 4C, the electronic device 101 may select the first external electronic device 331 to process the first specific task 424 and the second external electronic device 332 to process the second specific task 425.

According to various embodiments, the electronic device 101 (e.g., the processor 120 of FIG. 1) may assign processing of the specific task 320 to the external electronic device 330. For example, referring to FIG. 4C, the electronic device 101 may assign processing of the first specific task 424 to the first external electronic device 331 and may assign processing of the second specific task 425 to the second external electronic device 332. In this case, the electronic device 101 may transmit a first neural network model (e.g., noise cancellation model) for processing the first specific task 424 to the first external electronic device 331, and may transmit a second neural network model (e.g., noise cancellation model) for processing the second specific task 425 to the second external electronic device 332. According to an embodiment, the electronic device 101 may request the external electronic device 330 to terminate a previously performed task and may assign processing of the task requested to be terminated to another external electronic device. For example, referring to FIG. 4B and FIG. 4C, the electronic device 101 may request the first external electronic device 331 to terminate the previously performed specific task 423 (e.g., car horn detection), while assigning processing of the specific task 423 to another external electronic device (e.g., the smart watch 335) if the context information (e.g., outdoor) related to the specific task 423 is maintained.

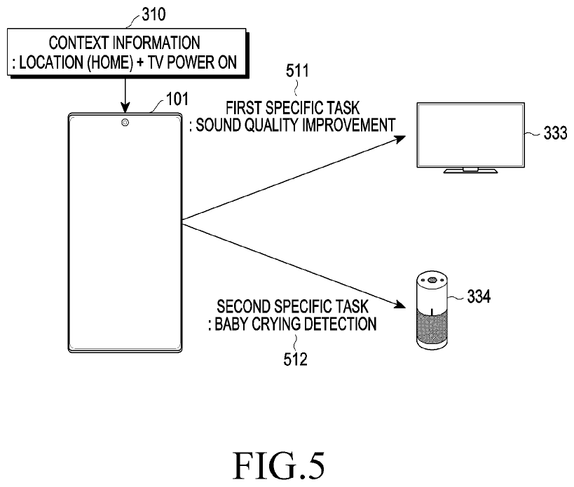

According to various embodiments, FIG. 5 illustrates a diagram of an embodiment wherein an electronic device (e.g., the electronic device 101 of FIG. 1) identifies context information (e.g., the context information 310 of FIG. 3) by using information received from an external electronic device (e.g., the external electronic device 330 of FIG. 3), and assigns a specific task (e.g., the specific task 320 of FIG. 3) to the external electronic device 330 on the basis of the identified context information 310.

According to various embodiments, the electronic device 101 (e.g., the processor 120 of FIG. 1) may identify the context information 310. The context information 310 may include at least one of context information relating to the electronic device 101, context information relating to an audio signal, or context information relating to the external electronic device 330. According to an embodiment, the electronic device 101 may receive context information of the external electronic device 330 that is establishing a communication connection, from the external electronic device 330. For example, referring to FIG. 5, the electronic device 101 may identify, as the context information 310, location information (e.g., home) of the electronic device 101 and state information (e.g., TV power on) of the external electronic device 333 (e.g., smart TV).

According to various embodiments, the electronic device 101 (e.g., the processor 120 of FIG. 1) may select the specific task 320 corresponding to the context information 310 from among predetermined inference tasks. For example, referring to FIG. 5, the electronic device 101 may select a first specific task 511 (e.g., sound quality improvement) and a second specific task 512 (e.g., baby crying detection) which correspond to the context information 310 (e.g., location (home) and TV power (on)).

According to various embodiments, the electronic device 101 (e.g., the processor 120 of FIG. 1) may select the external electronic device 330 to process the specific task 320 from among external electronic devices which are establishing a communication connection to the electronic device 101. For example, referring to FIG. 5, the electronic device 101 may select the first external electronic device 333 (e.g., smart TV) to process the first specific task 511 and the second external electronic device 334 (e.g., artificial intelligence speaker) to process the second specific task 512.

According to various embodiments, the electronic device 101 (e.g., the processor 120 of FIG. 1) may assign processing of the specific task 320 to the external electronic device 330. For example, referring to FIG. 5, the electronic device 101 may assign processing of the first specific task 511 to the first external electronic device 333 and may assign processing of the second specific task 512 to the second external electronic device 334. In this case, the electronic device 101 may transmit a first neural network model (e.g., sound quality improvement model) for processing the first specific task 511 to the first external electronic device 333, and may transmit a second neural network model (e.g., baby crying detection model) for processing the second specific task 512 to the second external electronic device 334.

FIG. 6A illustrates a flowchart for describing a method for selecting, by an electronic device (e.g., the electronic device 101 of FIG. 1), an external electronic device (e.g., the external electronic device 330 of FIG. 3) to process a specific task (e.g., the specific task 320 of FIG. 3).

According to various embodiments, FIG. 6B illustrates a diagram of an embodiment, in which the electronic device 101 selects the external electronic device 330 to process the specific task 320.

According to various embodiments, in operation 601, the electronic device 101 (e.g., the processor 120 of FIG. 1) may identify whether the specific task 320 corresponding to identified context information (e.g., the context information of FIG. 3) is processible by only a specific external electronic device. According to an embodiment, some of the predetermined inference tasks may be pre-designated to be processed only by a specific external electronic device. For example, an active noise cancellation task may be pre-designated as a task that is processible by only at least one of a left earbud (e.g., the left earbud 331 in FIG. 3) or a right earbud (e.g., the right earbud 332 in FIG. 3), and a device other than the left earbud 331 and the right earbud 332 may be pre-designated not to process the noise cancellation task. As another example, a sound scene classification task may be pre-designated as a task that is processible by any external electronic device. In this regard, referring to FIG. 6B, the electronic device 101 may identify the specific task 320 (e.g., noise cancellation) corresponding to the context information 310 (e.g., ambient noise is equal to or lower than a critical SNR), and may confirm that the noise cancellation task is designated as a task that is processible by only earbuds. As another example, referring to FIG. 6B, the electronic device 101 may identify the specific task 620 (e.g., sound scene classification task) corresponding to the context information 310 (e.g., call application execution), and may confirm that the sound scene classification task is designated as a task that is processible by any external electronic device.

According to various embodiments, in operation 603, if the specific task 320 is a task processible by only a specific external electronic device, the electronic device 101 (e.g., the processor 120 of FIG. 1) may select the specific external electronic device as the external electronic device 330 to process the specific task 320, and may identify whether the specific external electronic device is performing another task. For example, the electronic device 101 may select the specific external electronic device as the external electronic device 330 to process the specific task 320, may transmit a message for inquiring whether the specific external electronic device performs a task, and may identify whether the specific external electronic device is performing a task other than noise cancellation, on the basis of a response message (e.g., acknowledgement or non-acknowledgement) received from the external electronic device.

According to various embodiments, in operation 605, if the specific external electronic device is performing another task, the electronic device 101 (e.g., the processor 120 of FIG. 1) may request termination of the another task, and may assign processing of the another task, which has been requested to be terminated, to an external electronic device other than the specific external electronic device. For example, the electronic device 101 may request termination of another task (e.g., car horn detection task) which is being performed by the left earbud 331, and may request processing of the car horn detection task, from another external electronic device. The electronic device 101 may assign the task that is being performed by the specific external electronic device to another external electronic device by using operations 609 to 615.

According to various embodiments, in operation 607, the electronic device 101 (e.g., the processor 120 of FIG. 1) may assign processing of the specific task 320 corresponding to the context information 310 to the external electronic device. According to an embodiment, if the specific external electronic device is not performing the another task, the electronic device 101 may assign the specific task 320 to the specific external electronic device. According to an embodiment, the electronic device 101 may assign the specific task 320 to the specific external electronic device, while requesting the specific external electronic device to terminate performing of the another task. For example, referring to FIG. 6B, the electronic device 101 may assign the specific task 320 (e.g., noise cancellation task) corresponding to the context information 310 (e.g., ambient noise is equal to or lower than a critical SNR) to the left earbud 331 and the right earbud 332.

According to various embodiments, in operation 609, if the specific task 320 is not a task that is processible by only a specific external electronic device, the electronic device 101 (e.g., the processor 120 of FIG. 1) may identify at least one external electronic device that is not performing a task. For example, the electronic device 101 may identify at least one external electronic device (e.g., the smart TV 333, the artificial intelligence speaker 334, and the smart watch 335), which is not performing a task, from among external electronic devices that are establishing a communication connection to the electronic device 101. According to an embodiment, the electronic device 101 may transmit an inquiry message relating to task performance to each of the external electronic devices which are establishing a communication connection, and may select at least one external electronic device, which is not performing a task, on the basis of the received response message (e.g., acknowledgement or non-acknowledgement).

According to various embodiments, in operation 611, the electronic device 101 (e.g., the processor 120 of FIG. 1) may identify one or more external electronic devices capable of processing input data to be used for the specific task 320. According to an embodiment, the electronic device 101 may identify one or more external electronic devices capable of processing input data to be used for the specific task 320 from among at least one external electronic device that is not performing a task. For example, the electronic device 101 may select one or more external electronic devices (e.g., the artificial intelligence speaker 334 and the smart watch 335) capable of processing input data to be used for the specific task 320, from among at least one external electronic device (e.g., the smart TV 333, the artificial intelligence speaker 334, and the smart watch 335) which is not performing a task. According to an embodiment, the electronic device 101 may identify one or more external electronic devices including a microphone for detecting an audio signal to be used for the specific task 320. For example, the electronic device 101 may include a built-in microphone, and may select the earbuds 331 and 332, the artificial intelligence speaker 334, and the smart watch 335 which are capable of detecting ambient sounds via the microphone. According to an embodiment, the electronic device 101 may identify one or more external electronic devices capable of fetching, as input data, an audio signal to be used for the specific task 320. According to an embodiment, the electronic device 101 may transmit an inquiry message relating to processible input data to each of at least one external electronic device that is not performing a task, and may select one or more external electronic devices capable of processing input data to be used for the specific task 320, on the basis of the received response message.

According to various embodiments, in operation 613, the electronic device 101 (e.g., the processor 120 of FIG. 1) may identify at least one candidate electronic device in which a resource to be used for processing the specific task 320 exists. According to an embodiment, the electronic device 101 may identify at least one candidate electronic device, in which a resource to be used for processing the specific task 320 exists, from among the one or more external electronic devices capable of processing the input data to be used for the specific task 320. According to an embodiment, the electronic device 101 may select at least one candidate electronic device (e.g., the smart watch 335) in which a resource to be used for processing the specific task 320 exists, from among one or more external electronic devices (e.g., the artificial intelligence speaker 334 and the smart watch 335) capable of processing the input data to be used for the specific task 320. According to an embodiment, the electronic device 101 may transmit an inquiry message relating to an available resource to each of the one or more external electronic devices capable of processing the input data to be used for the specific task 320, and may select at least one candidate electronic device in which a resource to be used for processing the specific task 320 exists, on the basis of the received response message. According to an embodiment, operation 611 described above can be omitted, and operation 613 described later may be performed immediately after operation 609. For example, the electronic device 101 may identify at least one external electronic device, which is not performing a task, from among external electronic devices, and may identify at least one candidate electronic device, in which a resource to be used for processing the specific task 320 exists, from among at least one external electronic device.

According to various embodiments, in operation 615, the electronic device 101 (e.g., the processor 120 of FIG. 1) may select the external electronic device 330 to process the specific task 320. According to an embodiment, the electronic device 101 may select the external electronic device 330 to process the specific task 320 from among at least one candidate electronic device in which a resource to be used for processing the specific task 320 exists. For example, referring to FIG. 6B, the electronic device 101 may select the external electronic device 330 (e.g., the smart watch 335) to process the specific task 320 from among at least one candidate electronic device in which a resource exists. According to an embodiment, the electronic device 101 may randomly select the external electronic device 330 from among at least one candidate electronic device. According to an embodiment, the electronic device 101 may select a device having the most available resources, as the external electronic device 330 to process the specific task 320, from among at least one candidate electronic device.

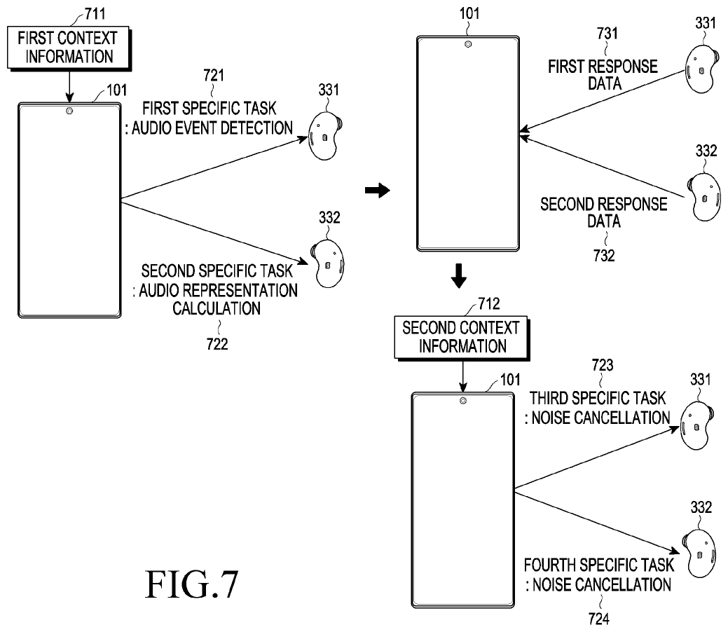

According to various embodiments, FIG. 7 illustrates a diagram of an embodiment in which an electronic device (e.g., the electronic device 101 of FIG. 1) updates context information (e.g., the context information 310 of FIG. 3) and assigns a specific task (e.g., the specific task 320 in FIG. 3) to an external electronic device (e.g., the external electronic device 330 of FIG. 3) on the basis of the updated context information (310).

According to various embodiments, the electronic device 101 (e.g., the processor 120 of FIG. 1) may assign the specific task 320 corresponding to the context information 310 to the external electronic device 330. For example, referring to FIG. 7, the electronic device 101 may select a first specific task 721 (e.g., audio event detection) and a second specific task 722 (e.g., audio representation calculation) which corresponds to first context information 711 (e.g., a user is located outdoor), wherein the electronic device 101 may assign the first specific task 721 to the left earbud 331 and may assign the second specific task 722 to the right earbud 332 from among external electronic devices which are establishing a communication connection to the electronic device 101.

According to various embodiments, the electronic device 101 (e.g., the processor 120 of FIG. 1) may receive a result of processing the specific task 320 from the external electronic device 330 via a communication module (e.g., the communication module 190 of FIG. 1). For example, referring to FIG. 7, the electronic device 101 may receive first response data 731 (e.g., detected audio event) as a result of processing the first specific task 721 from the left earbud 331, and may receive second response data 732 (e.g., embedding corresponding to a result of obtaining audio representation) as a result of processing a second specific task 722 from the right earbud 332.

According to various embodiments, the electronic device 101 (e.g., the processor 120 of FIG. 1) may update the context information 310 on the basis of the result of processing the specific task 320, which is received from the external electronic device 330. According to an embodiment, the electronic device 101 may apply the result of processing the specific task 320 to a neural network model for sound scene classification, and may acquire surrounding environment information corresponding to a identified sound scene. For example, referring to FIG. 7, the electronic device 101 may apply at least one of the first response data 731 or the second response data 732 to the neural network model for sound scene classification, and may acquire the surrounding environment information (e.g., the user is located in a subway station) corresponding to the identified sound scene, as second context information 712. In this case, the electronic device 101 may update the first context information 711 (e.g., the user is located outdoor) to the second context information 712 (e.g., the user is located in a subway station).

According to various embodiments, the electronic device 101 (e.g., the processor 120 of FIG. 1) may select a subsequent task corresponding to the updated context information from among predetermined inference tasks. For example, referring to FIG. 7, the electronic device 101 may select a third specific task 723 (e.g., noise cancellation) and a fourth specific task 724 (e.g., noise cancellation) which correspond to the second context information 712.

According to various embodiments, the electronic device 101 (e.g., the processor 120 of FIG. 1) may assign the selected subsequent task to the external electronic device 330. For example, referring to FIG. 7, the electronic device 101 may assign the third specific task 723 to the left earbud 331 and may assign the fourth specific task 724 to the right earbud 332. According to an embodiment, the electronic device 101 may assign the subsequent task to the external electronic device 330, while assigning the specific task 320 previously being performed by the external electronic device 330 to another external electronic device 330. For example, referring to FIG. 7, the electronic device 101 may assign the third specific task 723 to the left earbud 331, and may assign the fourth specific task 724 to the right earbud 332, while assigning the first specific task 721 being performed by the left earbud 331 to the artificial intelligence speaker 334 and assigning the second specific task 722 being performed by the right earbud 332 to the smart watch 335. The operations described in FIG. 6A may be used for a method of assigning each task.

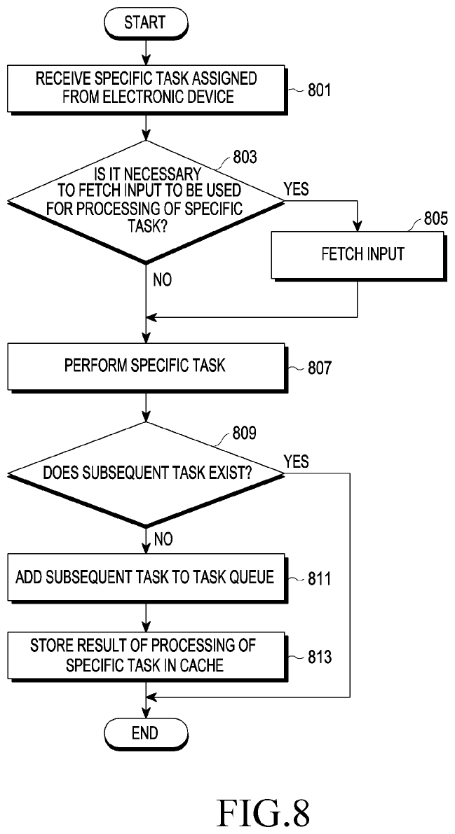

According to various embodiments, FIG. 8 illustrates a flowchart for describing a method for performing, by an external electronic device (e.g., the external electronic device 330 of FIG. 3), a specific task (e.g., the specific task 320 of FIG. 3) assigned by an electronic device (e.g., the electronic device 101 of FIG. 1).

According to various embodiments, in operation 801, the external electronic device 330 may receive the specific task 320 assigned from the electronic device 101. For example, the external electronic device 330 may receive, from the electronic device 101, a request for processing the specific task 320. The external electronic device 330 may pre-store a neural network model for processing the specific task 320, or may receive, from the electronic device 101, the neural network model along with the request for processing the specific task 320.

According to various embodiments, in operation 803, the external electronic device 330 may identify whether it is necessary to fetch an input to be used for processing of the specific task 320.

According to various embodiments, in operation 805, if it is necessary to fetch an input, the external electronic device 330 may fetch the input. According to an embodiment, the external electronic device 330 may fetch, as input data, an audio signal received from the electronic device 101 or another external electronic device.

According to various embodiments, in operation 807, if it is not necessary to fetch the input or if the fetch has been completed, the external electronic device 330 may perform the specific task 320. According to an embodiment, the electronic device 101 may perform the specific task 320 by applying audio data corresponding to the input data to the neural network model trained to perform the specific task 320.

According to various embodiments, in operation 809, the external electronic device 330 may identify whether a subsequent task exists. According to an embodiment, the external electronic device 330 may be assigned a subsequent task from the electronic device 101 while performing the specific task 320.

According to various embodiments, in operation 811, if a subsequent task exists, the external electronic device 330 may add the subsequent task to a task queue.

According to various embodiments, in operation 813, when the specific task 320 is fully processed, the external electronic device 330 may store a result of processing the specific task 320 in a cache so that the result of processing the specific task 320 can be used in a subsequent task performing procedure. According to an embodiment, the external electronic device 330 may perform the subsequent task by using the cached result of processing the specific task 320 and a neural network model corresponding to the subsequent task.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments, an electronic device may include a communication module, and a processor, wherein the processor is configured to: identify context information; select a specific task corresponding to the context information from among predetermined inference tasks relating to processing of an audio signal; select an external electronic device, which is to process the specific task, from among external electronic devices that are establishing a communication connection to the electronic device; and assign processing of the specific task to the external electronic device.

According to various embodiments, the context information may include at least one of context information relating to the electronic device, context information relating to the external electronic device, or context information relating to the audio signal.

According to various embodiments, it may be configured to identify, as the context information, location information of the electronic device, and to select the specific task corresponding to the location information of the electronic device.

According to various embodiments, it may be configured to identify, as the context information, surrounding environment information of the electronic device by using a neural network model for sound scene classification, and to select the specific task corresponding to the surrounding environment information of the electronic device.

According to various embodiments, the processor may be configured to identify whether the specific task is processible by only a specific external electronic device.

According to various embodiments, the processor may be configured to: if the specific task is a task that is processible by only the specific external electronic device, select the specific external electronic device as the external electronic device to process the specific task; identify whether the specific external electronic device is performing another task; if the specific external electronic device is performing another task, request the specific external electronic device to terminate performing of the another task; and assign processing of the another task to an external electronic device other than the specific external electronic device from among the external electronic devices.

According to various embodiments, the processor may be configured to, if the specific task is not a task that is processible by only the specific external electronic device, identify at least one external electronic device that is not performing a task from among the external electronic devices.

According to various embodiments, the processor may be configured to identify one or more external electronic devices capable of processing input data to be used for the specific task from among the at least one external electronic device.

According to various embodiments, the processor may be configured to: identify at least one candidate electronic device, in which a resource to be used for processing of the specific task exists, from among the one or more external electronic devices; and select the external electronic device from among the at least one candidate electronic device.

According to various embodiments, the processor may be configured to: receive a result of processing the specific task from the external electronic device, via the communication module; update the context information on the basis of the result of processing the specific task; select a subsequent task corresponding to the updated context information; and assign the subsequent task to the external electronic device.

According to various embodiments, an operation method of an electronic device may include: identifying context information; selecting a specific task corresponding to the context information from among predetermined inference tasks relating to processing of an audio signal; selecting an external electronic device, which is to process the specific task, from among external electronic devices that are establishing a communication connection to the electronic device; and assigning processing of the specific task to the external electronic device.

According to various embodiments, the identifying of the context information may include identifying, as the context information, location information of the electronic device, and the selecting of the specific task may include selecting the specific task corresponding to the location information of the electronic device.

According to various embodiments, the identifying of the context information may include identifying, as the context information, surrounding environment information of the electronic device by using a neural network model for sound scene classification, and the selecting of the specific task may include selecting the specific task corresponding to the surrounding environment information of the electronic device.

According to various embodiments, the selecting of the external electronic device may include identifying whether the specific task is a task that is processible by only a specific external electronic device.

According to various embodiments, the selecting of the external electronic device may include: if the specific task is a task that is processible by only the specific external electronic device, selecting the specific external electronic device as the external electronic device to process the specific task; identifying whether the specific external electronic device is performing another task; if the specific external electronic device is performing another task, requesting the specific external electronic device to terminate performing of the another task; and assigning processing of the another task to an external electronic device other than the specific external electronic device from among the external electronic devices.

According to various embodiments, the selecting of the external electronic device may include, if the specific task is not a task that is processible by only the specific external electronic device, identifying at least one external electronic device that is not performing a task from among the external electronic devices.

According to various embodiments, the selecting of the external electronic device may include identifying one or more external electronic devices capable of processing input data to be used for the specific task from among the at least one external electronic device.

According to various embodiments, the selecting of the external electronic device may include: identifying at least one candidate electronic device, in which a resource to be used for processing of the specific task exists, from among the one or more external electronic devices; and selecting the external electronic device from among the at least one candidate electronic device.

According to various embodiments, the operation method of the electronic device may further include: receiving a result of processing the specific task from the external electronic device, via the communication module; updating the context information on the basis of the result of processing the specific task; selecting a subsequent task corresponding to the updated context information; and assigning the subsequent task to the external electronic device.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a communication module; and
a processor, wherein the processor is configured to:
identify context information;
select a specific task corresponding to the context information from among predetermined inference tasks relating to processing of an audio signal;
select an external electronic device, which is to process the specific task, from among external electronic devices that are establishing a communication connection to the electronic device; and
assign processing of the specific task to the external electronic device.

2. The electronic device of claim 1, wherein the context information comprises at least one of:
context information relating to the electronic device,
context information relating to the external electronic device, or
context information relating to the audio signal.

3. The electronic device of claim 1, wherein the processor is further configured to:
identify, as the context information, location information of the electronic device; and
select the specific task corresponding to the location information of the electronic device.

4. The electronic device of claim 1, wherein the processor is further configured to:
identify, as the context information, surrounding environment information of the electronic device by using a neural network model for sound scene classification; and
select the specific task corresponding to the surrounding environment information of the electronic device.

5. The electronic device of claim 1, wherein the processor is further configured to identify whether the specific task is a task that is processible by only a specific external electronic device.

6. The electronic device of claim 5, wherein the processor is further configured to:
if the specific task is a task that is processible by only the specific external electronic device, select the specific external electronic device as the external electronic device to process the specific task, and identify whether the specific external electronic device is performing another task;
if the specific external electronic device is performing the another task, request the specific external electronic device to terminate the performing of the another task; and
assign processing of the another task to an external electronic device other than the specific external electronic device from among the external electronic devices.

7. The electronic device of claim 5, wherein when the specific task is not a task that is processible by only the specific external electronic device the processor is configured to identify at least one external electronic device that is not performing a task from among the external electronic devices.

8. The electronic device of claim 7, wherein the processor is further configured to identify one or more external electronic devices capable of processing input data to be used for the specific task from among the at least one external electronic device.

9. The electronic device of claim 8, wherein the processor is further configured to:
identify at least one candidate electronic device, in which a resource to be used for processing of the specific task exists, from among the one or more external electronic devices; and
select the external electronic device from among the at least one candidate electronic devices.

10. The electronic device of claim 1, wherein the processor is further configured to:
receive a result of processing the specific task from the external electronic device, via the communication module;
update the context information based on the result of processing the specific task;
select a subsequent task corresponding to the updated context information; and
assign the subsequent task to the external electronic device.

11. An operation method of an electronic device, the method comprising:
identifying context information;
selecting a specific task corresponding to the context information from among predetermined inference tasks relating to processing of an audio signal;
selecting an external electronic device, which is to process the specific task, from among external electronic devices that are establishing a communication connection to the electronic device; and
assigning processing of the specific task to the external electronic device.

12. The method of claim 11, wherein the context information comprises at least one of:
context information relating to the electronic device,
context information relating to the external electronic device, or
context information relating to the audio signal.

13. The method of claim 11, wherein:
identifying the context information comprises identifying, as the context information, location information of the electronic device; and
selecting the specific task comprises selecting the specific task corresponding to the location information of the electronic device.

14. The method of claim 11, wherein:
identifying the context information comprises identifying, as the context information, surrounding environment information of the electronic device by using a neural network model for sound scene classification; and
selecting the specific task comprises selecting the specific task corresponding to the surrounding environment information of the electronic device.

15. The method of claim 11, wherein selecting the external electronic device comprises identifying whether the specific task is a task that is processible by only a specific external electronic device.

16. The method of claim 15, wherein:
the selecting of the external electronic device comprises:
when the specific task is a task that is processible by only the specific external electronic device, selecting the specific external electronic device as the external electronic device to process the specific task, and identifying whether the specific external electronic device is performing another task; and
when the specific external electronic device is performing the another task, requesting the specific external electronic device to terminate the performing of the another task, and
the method further comprises assigning processing of the another task to an external electronic device other than the specific external electronic device from among the external electronic devices.

17. The method of claim 15, wherein selecting the external electronic device comprises, if the specific task is not a task that is processible by only the specific external electronic device, identifying at least one external electronic device that is not performing a task from among the external electronic devices.

18. The method of claim 17, wherein selecting the external electronic device comprises identifying one or more external electronic devices capable of processing input data to be used for the specific task from among the at least one external electronic device.

19. The method of claim 18, wherein selecting the external electronic device comprises:
identifying at least one candidate electronic device, in which a resource to be used for processing of the specific task exists, from among the one or more external electronic devices; and
selecting the external electronic device from among the at least one candidate electronic devices.

20. The method of claim 11, further comprising:
receiving a result of processing the specific task from the external electronic device, via a communication module of the electronic device;
updating the context information based on the result of processing the specific task;
selecting a subsequent task corresponding to the updated context information; and
assigning the subsequent task to the external electronic device.
